(19) United States
(12) Patent Application Publication
(10) Pub. No.: US 2006/0088288 A1
(43) Pub. Date: Apr. 27, 2006

(54) Auxiliary operation interface of digital recording and reproducing apparatus

(75) Inventor: Chia-Hsiang Lin, Hsinchu (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Lite-On It Corp.

(21) Appl. No.: 11/255,058

(22) Filed: Oct. 20, 2005

(30) Foreign Application Priority Data
Oct. 22, 2004 (TW) 093132231
Oct. 22, 2004 (TW) 093132232

(51) Int. Cl. H04N 5/76; G06F 13/00; G06F 3/00

(52) U.S. Cl. 386/83; 725/58

(57) ABSTRACT

An auxiliary operation interface includes a guiding menu and an audio prompt generator. The guiding menu has a targeting item optionally triggered to have the digital recording/reproducing apparatus execute a selected function. The audio prompt generator is enabled to generate a first audio prompt when the targeting item is triggered to enter a first function and generate a second audio prompt when the targeting item is triggered to enter a second function.

### FIELD OF THE INVENTION

The present invention relates to an auxiliary operation interface, and more particularly to an auxiliary operation interface and a method for facilitating a user to operate a digital recording/reproducing apparatus.

### BACKGROUND OF THE INVENTION

Referring to FIG. 1, a functional block diagram of a typical digital recording/reproducing apparatus is shown. A digital recording/reproducing apparatus 10, for example a DVD recorder, is used to record video data into a recordable disc or reproduce video data from a readable disc. Nowadays, the digital recording/reproducing apparatus 10 can be used with various kinds of electrical appliances to record video data from various sources. For example, the analog video signals received from the TV tuner 11 are transmitted to the control circuit 16 to be converted into digital data in a specified format such as MPEG. The digital data in the MPEG format are then recorded into a recordable disc 15 loaded in the disc burner 17 of the DVD recorder 10. Likewise, the analog video signals received from the video cassette recorder (VCR) 12, the DVD player 13, or the digital video signals received from the digital video (DV) camera 14 can also be converted into digital data in a specified format such as MPEG by the control circuit 16 to be recorded into the recordable disc 15.

Referring to FIG. 2, a functional block diagram of another digital recording/reproducing apparatus is shown. The digital recording/reproducing apparatus 100 comprises a disc burner 102, a control circuit 106, and a digital data storage device such as a hard disc drive 101. The signals received from the TV tuner 11, the VCR 12, the DVD player 13, or the DV camera 14 are firstly converted into digital data in a specified format such as MPEG by the control circuit 106. The MPEG digital data are then stored in the hard disc drive 101 in an editable manner. The edited digital data is then recorded into the recordable disc 15 by the disc burner 102. On the other hand, it is also possible to record the data previously stored in the disc 15 into the hard disc drive 101.

Since the digital recording/reproducing apparatus mentioned above exhibits functions of record and playback and generally has other extended uses, for example scheduled record, the operating interface for control of the digital recording/reproducing apparatus, such as a remote controller, would be quite complex. The complicated operating interface becomes hindrance from using the digital recording/reproducing apparatus, particularly for the elderly or uneducated users. Recently, a graphic-based user interface, so called as “easy guider”, was developed to make the control more user-friendly. For example, when an actuating button on a remote controller is pressed down, a comprehensible guiding menu consisting of several selective items is shown on the screen. Following the instructions shown on the screen, the user can navigate functions of the digital recording/reproducing apparatus by moving the cursor to the desired operation item on a step-by-step basis.

FIGS. 3(a), 3(b), 3(c), 3(d) and 3(e) schematically show various guiding menus sequentially displayed for guiding the user to control the digital recording/reproducing apparatus to execute the recording function. In the main menu of FIG. 3(a), items of playback, record, erase, and finalize are provided for user's selection. In this case that a record function is to be executed, the term “Record” is selected by moving the highlight cursor to the desired visual key 31 on the screen with the up/down buttons of the remote controller and pushing the “Enter” button under this circumstance. Then, a sub-menu of FIG. 3(b) will be shown for further selection. In this sub-menu, the video source including TV, AV1, AV2, S-Video or DV is to be selected. If the TV video source is selected by moving the highlight cursor to the desired visual key 32 on the screen with the up/down buttons of the remote controller and the “Enter” button is pushed down under this circumstance, a further menu will be shown for the user to select the channel that is to be recorded, as shown in FIG. 3(c). By pushing the channel up/down buttons, the digits in the visual key 33 will change. After the desired channel is located, push “Enter” to enter next menu, as shown in FIG. 3(d), to select the recording quality and the recording period. For example, the HQ mode offers the highest resolution with highest bit rate. However, only 1 hour of video can be recorded in this mode. The SP mode has a lower bit rate, but the video quality is still very good. The video quality with the EP and SLP isn't nearly as good, but a lot of video data can be fit onto one disc in these modes. After the user selects the desired recording period/quality, e.g. 2 hrs/SP, via the visual key 34 and then pushes “Enter”, the frame as shown in FIG. 3(e) will be shown. In this menu, the recording operation is started upon the visual key 35 indicating the term “Go” is pushed.

In addition to the above-mentioned easy guider menu, other guiding menus such as set-up menus are also commonly used to do necessary settings on a step-by-step basis. FIGS. 3(f) and 3(g) schematically show two set-up menus sequentially displayed for guiding the user to execute the recording function of the digital recording/reproducing apparatus. In the main menu of FIG. 3(f), items of playback, record, erase, finalize, etc. are provided for user's selection. For executing the record function, the item “Record” is selected by moving the highlight cursor to the desired visual key on the screen with the up/down/left/right buttons of the remote controller and pushing the “Enter” button under this circumstance. Then, a sub-menu as shown in FIG. 3(g) will be displayed for further selection. In this sub-menu, the video source, channel, recording quality and recording period can be selected and set one by one by moving the highlight cursor to the desired visual key on the screen with the up/down/left/right selection buttons or numerical buttons of the remote controller. Moreover, the visualized user interface can also be applied to execute other extensive functions such as file management or schedule setting.

The “easy guider” operating interface or set-up operating interface, although alleviating complexity problem by minimizing real buttons on the remote controller, is still not user-friendly enough. Since the text and graphic symbols shown on the screen is very simple, some users may have problem in realizing or memorizing the meaning of the visual keys or need to look it up in the handbook. Therefore, the operation of the easy guider needs to be further improved.

### SUMMARY OF THE INVENTION

The present invention provides an auxiliary operation interface of a digital recording/reproducing apparatus to help the user well understand what he can do under the displayed easy guider menu. The present invention also suggests how to facilitate a user to operate a digital recording/reproducing apparatus.

In accordance with a first aspect of the present invention, there is provided an auxiliary operation interface of a digital recording/reproducing apparatus. The auxiliary operation interface comprises a guiding menu and an audio prompt generator. The guiding menu has a targeting item optionally triggered to have the digital recording/reproducing apparatus execute a selected function. The audio prompt generator is enabled to generate a first audio prompt when the targeting item is triggered to enter a first function and generate a second audio prompt when the targeting item is triggered to enter a second function.

In an embodiment, the guiding menu is shown on a screen coupled to the digital recording/reproducing apparatus and includes a plurality of selective items and the targeting item. The first or second function is entered by switching the targeting item to selectively lock one of the selective items and triggering the targeting item. The selected item could be locked and the targeting item could be triggered via a remote controller in communication with the digital recording/reproducing apparatus.

In an embodiment, the first and second audio prompts are sound prompts, and the audio prompt generator includes an audio process engine. In another embodiment, the first and second audio prompts are speech prompts, and the audio prompt generator includes a speech engine. The audio prompt generator includes a flash memory or hard disc drive for storing a plurality of audio files. Besides, the audio prompt generator could be implemented by integrated circuits for generating the first and second audio prompts. Preferably, the digital recording/reproducing apparatus is a DVD recorder or a DVD player.

In accordance with a second aspect of the present invention, there is provided a method for facilitating a user to operate a digital recording/reproducing apparatus. Firstly, a first menu having a plurality of selective items and a targeting item is entered. Then, a first one of the selective items is locked by switching the targeting item and the targeting item is triggered to enter a second menu. Or optionally a second one of the selective items is locked by switching the targeting item and the targeting item is triggered to enter a third menu. Afterward, a first audio prompt corresponding to the second menu is generated when the second menu is entered, and a second audio prompt corresponding to the third menu is generated when the third menu is entered.

In an embodiment, the first audio prompt and the second audio prompt are speech prompts. In another embodiment, the first audio prompt and the second audio prompt are sound prompts. The method may further comprise a step of selecting one of a plurality of audio files for generating the first or second audio prompts. The audio files could be speech files in a plurality of languages.

In an embodiment, the method further comprises a step of generating a third audio prompt when the digital recording/reproducing apparatus is powered on. Besides, the audio files could be downloaded from a designated website via the Internet.

In accordance with a third aspect of the present invention, there is provided an auxiliary operation interface of a digital recording/reproducing apparatus. The auxiliary operation interface comprises a control panel and an audio prompt generator. The control panel has a plurality of selective items, and the audio prompt generator is enabled to generate a first audio prompt when a first one of the selective items is selected as a targeting item, and generate a second audio prompt when a second one of the selective item is selected as the targeting item. The control panel is shown on a screen coupled to the digital recording/reproducing apparatus.

In an embodiment, the audio prompt generator further generates additional sound prompts to notify occurrences of specific operation events such as a set-up completed event, a page-switched event, an execution waiting event, a task completed event, a warning event, a set-up result event, a file erasing event or a machine code correcting event.

In accordance with a fourth aspect of the present invention, there is provided a method for facilitating a user to operate a digital recording/reproducing apparatus. Firstly, a guiding menu having a plurality of selective items is entered. Then a first audio prompt can be generated when a first one of the selective items is selected as a targeting item, and a second audio prompt can be generated when a second one of the selective items is selected as the targeting item. The guiding menu is shown on a screen coupled to the digital recording/reproducing apparatus.

The above contents of the present invention will become more readily apparent to those ordinarily skilled in the art after reviewing the following detailed description and accompanying drawings, in which:

### BRIEF DESCRIPTION OF THE DRAWINGS

FIG. 1 is a functional block diagram illustrating the use of a conventional digital recording/reproducing apparatus with a plurality of external data sources;

FIG. 2 is a functional block diagram illustrating the use of another conventional digital recording/reproducing apparatus with a plurality of external data sources;

FIGS. 3(a), 3(b), 3(c), 3(d) and 3(e) are schematic diagrams showing a series of easy guider menu for executing a recording operation;

FIGS. 3(f) and 3(g) are schematic diagrams showing a series of set-up menu for executing a recording operation;

FIG. 4 is a functional block diagram illustrating a digital recording/reproducing apparatus using an auxiliary operation interface according to a preferred embodiment of the present invention;

FIG. 5 is a flowchart illustrating the operation of the auxiliary operation interface for facilitating a user to operate the digital recording/reproducing apparatus according to the present invention;

FIG. 6 is a functional block diagram illustrating the sequence of selectively enabling or disabling the sound effect and speech effect with a single push button according to the present invention; and

FIG. 7 is a functional block diagram illustrating a remote controller for use with a digital recording/reproducing apparatus, which has the function of generating a sound prompt according to the present invention.

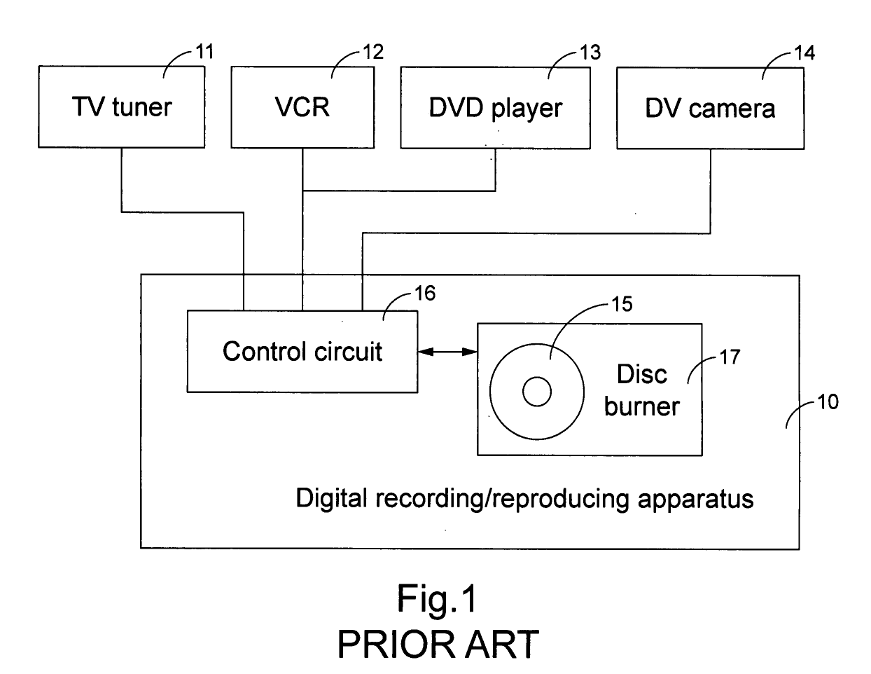

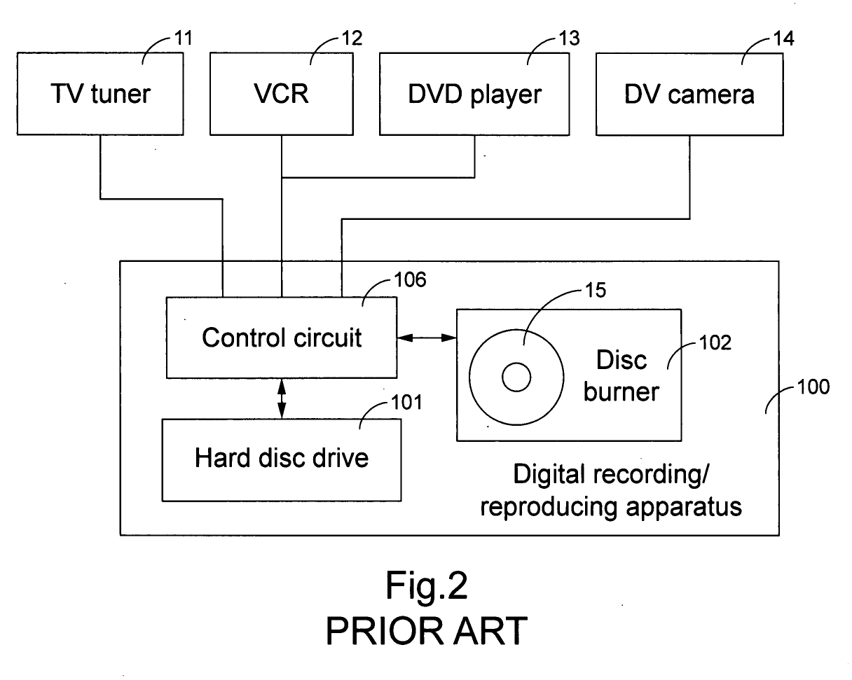

### DETAILED DESCRIPTION OF THE PREFERRED EMBODIMENT

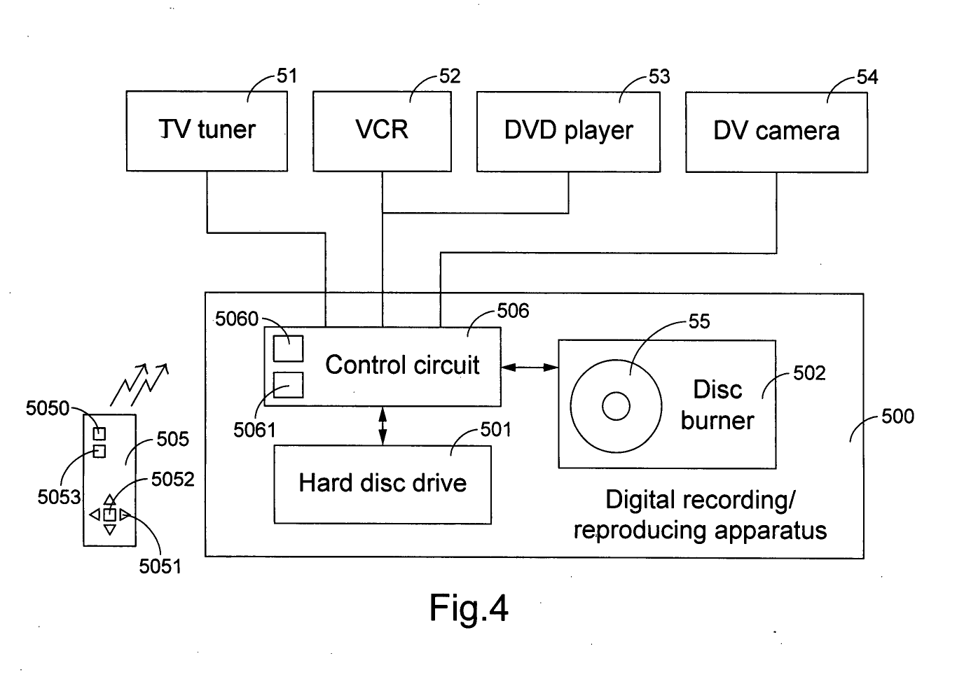

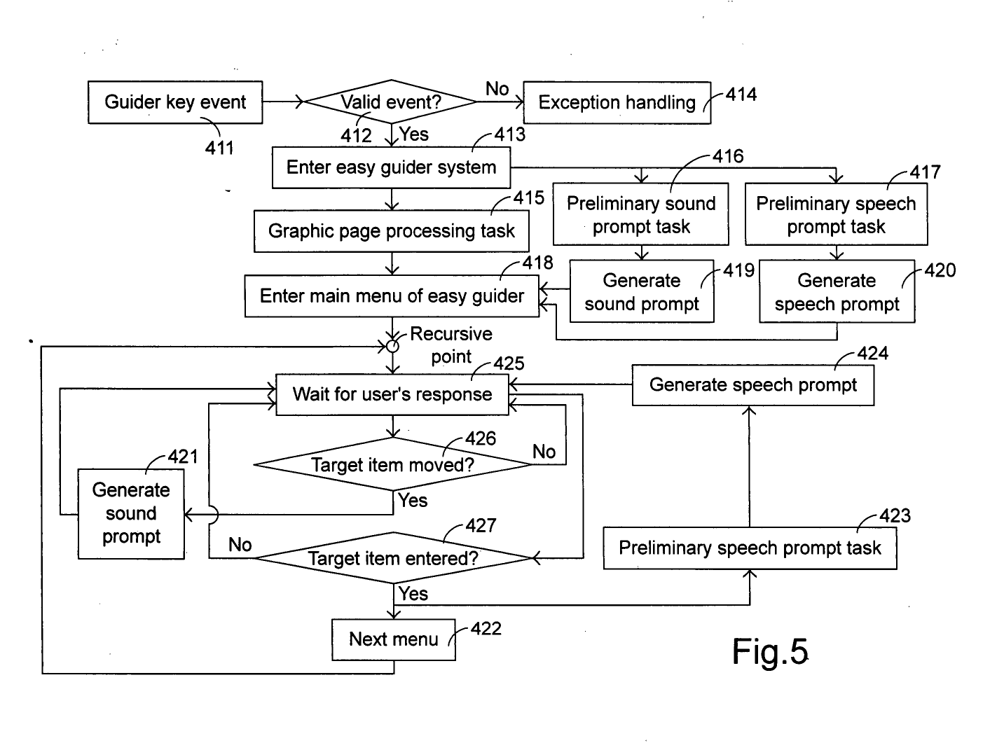

Hereinafter, an embodiment of an auxiliary operation interface and the operation of the auxiliary operation interface for facilitating a user to operate a digital recording/reproducing apparatus according to the present invention will be illustrated with reference to FIG. 4 and FIG. 5.

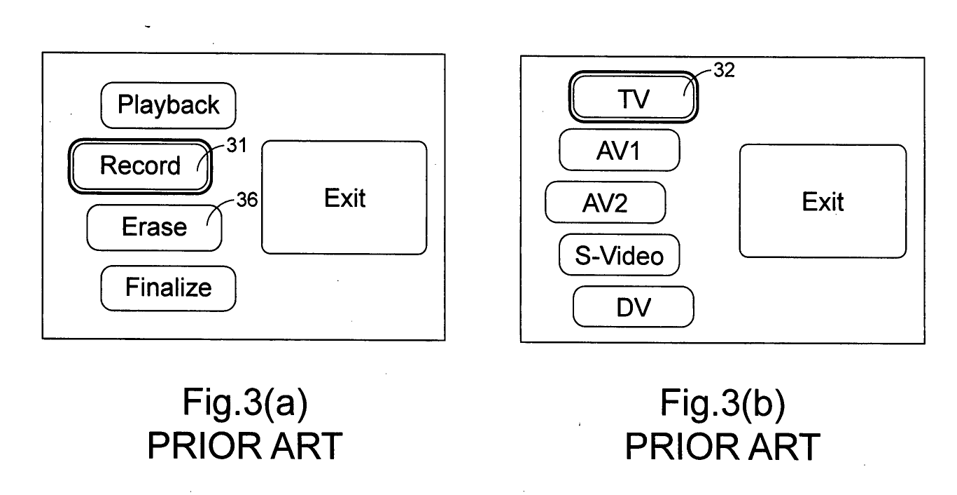

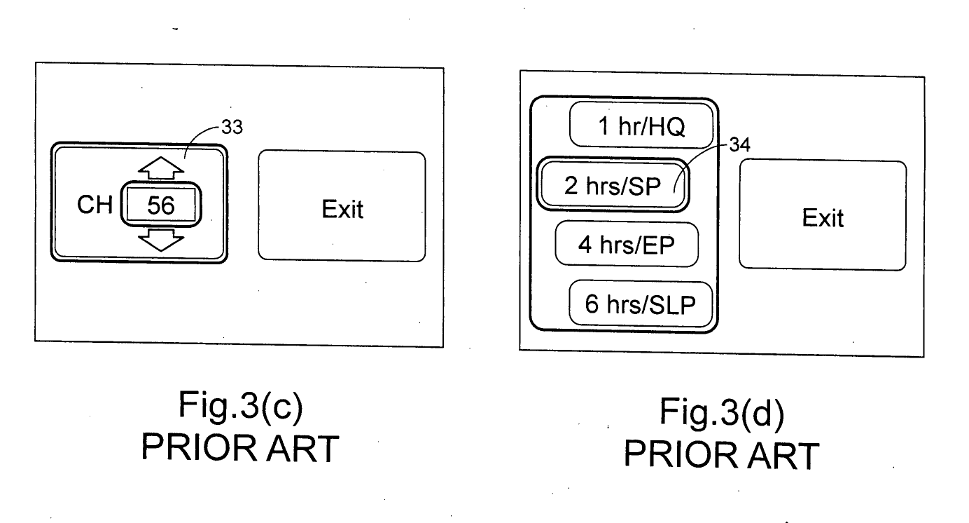

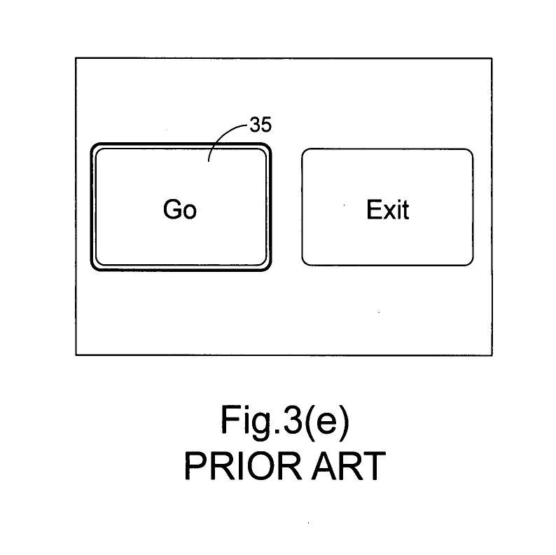

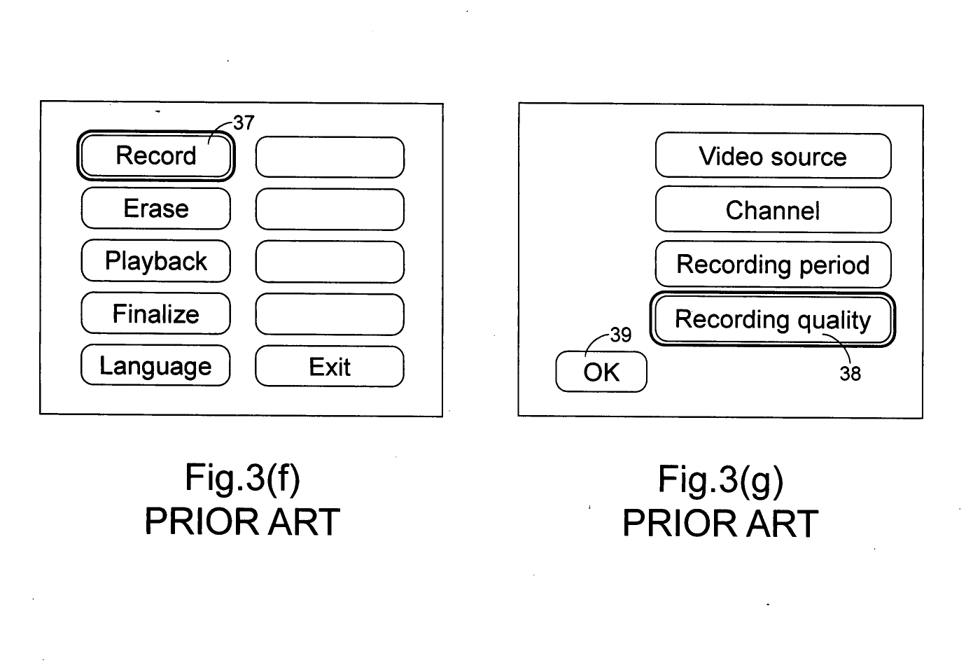

The auxiliary operation interface is used with a digital recording/reproducing apparatus 500 that comprises a disc burner 502, a control circuit 506, and a digital data storage device such as a hard disc drive 501. For recording data from an external source to a disc, the data signals received from the TV tuner 51, the VCR 52, the DVD player 53, or the DV camera 54 are firstly converted into digital data in a specified format such as MPEG by the control circuit 506. The MPEG digital data are then stored in the hard disc drive 501 in an editable manner. Afterwards, the edited digital data can be recorded into the recordable disc 55 by the disc burner 502. On the other hand, it is also possible to record the data previously stored in the disc 55 into the hard disc 501. The auxiliary operation interface includes a guiding menu shown on a screen such as those shown in FIGS. 3(a)˜3(e), a remote controller 505 in wireless communication with the digital recording/reproducing apparatus 500 for cooperating with the guiding menu, and an audio prompt generator implemented by integrated circuits consisting of an audio process engine 5060 and a speech engine 5061 disposed in the control circuit 506 of the digital recording/reproducing apparatus 500. The audio and/or speech prompts generated by the audio prompt generator help the user clearly understand what procedure is proceeding and how to make selection. Each of the audio process engine 5060 and the speech engine 5061 can be implemented with a flash memory or hard disc drive for storing a plurality of audio files.

First of all, referring to the flowchart of FIG. 5, by pushing an actuating button 5050 of the remote controller 505, a guider key event occurs (Step 411). If the guider key event is checked by the control circuit 506 and determined to be valid (Step 412), an easy guider system operation procedure is entered (Step 413). Otherwise, the guider key event is invalid and processed by an exception handling procedure (Step 414). In the system operation procedure, a graphic page processing task (Step 415), a preliminary sound prompt task (Step 416) and a preliminary speech prompt task (Step 417) are executed. After the graphic page processing task is performed, a main menu of the easy guider exemplified in FIG. 3(a) as a guiding menu is entered (Step 418) and displayed on the screen (not shown) coupled to the digital recording/reproducing apparatus 500. There are a plurality of selective items, e.g. playback, record, erase and finalize, included in the guiding menu. Meanwhile, the preliminary sound prompt task and preliminary speech prompt task are executed with an application program to locate pre-stored sound and speech data corresponding to the main menu and associated selective items according to respective identifying codes. Then, the located sound and speech data are processed into associated sound and speech prompts by the audio process engine 5060 and the speech engine 5061, respectively (Step 419 and Step 420). In a specific example, while entering the main menu, a speech prompt is outputted for describing the options of user through the main menu. Then, the user can make his selection. When the up/down/left/right selection buttons 5051 of the remote controller 505 are selectively manipulated to lock one of the selective items as a targeting item, a sound prompt is outputted to notify the switching of the targeting item (Step 421). For example, when the user triggers the “up” button of the remote controller 505 to switch the targeting item from the “Erase” key 36 into the “Record” key 31 as currently shown in FIG. 3(a), a sound prompt is outputted simultaneously. Optionally, a speech prompt can also be outputted to repeat the word “Record” or describe what the record key means and/or how it works, depending on the manufacturer's design. By pushing the “Enter” button 5052 of the remote controller 505, the targeting item “Record” is entered. Then, next menu is shown on the screen as another guiding menu (Step 422), e.g. that shown in FIG. 3(b). Meanwhile, a preliminary speech prompt task is executed (Step 423) and a speech prompt for describing the currently displayed menu is generated (Step 424). Likewise, the user can make his further selection through this menu (Steps 425, 426, 427) with the aid of audio and/or speech prompts (Step 421) and trigger another targeting item to enter next menu (Step 422) with the speech prompt describing the next menu for further selection (Steps 423, 424).

An example that a record function is to be executed is used herein to help with the understanding of the auxiliary operation interface according to the present invention. After the main menu of the easy guider system is entered, the highlight cursor should be moved to the desired visual key 31 as shown in the main menu of FIG. 3(a) with the selection button 5051 to lock the item “Record” as the targeting item. During the above procedure, the audio process engine 5060 generates a sound prompt whenever the targeting item changes, i.e. the highlighted cursor changes. Once the item “Record” is locked, the “Enter” button 5052 of the remote controller 505 is pressed down so that the recording function is selected. Then, the sub-menu of FIG. 3(b) is shown for further selection, and the speech engine 5061 generate a speech prompt associated with the contents of this menu. For example, the speech prompt can be “For recording, please select a video source among TV, AV1, AV2, S-Video and DV”. Of course, the speech prompt can be any other language that is available from the pre-stored speech data file or can be downloaded from the Internet. Preferably, a language selection key (not shown) is arranged in the guiding menu and/or a language selection button (not shown) is disposed in the remote controller to achieve this purpose. If the TV video source is selected as the targeting item by moving the highlight cursor to the desired visual key 32 on the screen with the up/down selection button 5051 and entered by pushing the “Enter” button 5052 of the remote controller 505, a further menu will be shown for the user to select the channel that is to be recorded, as shown in FIG. 3(c). Meanwhile, the speech engine 5061 will generate a speech prompt, for example “For recording, please select a TV channel as the video source”. By pushing the channel up/down buttons, the digits in the visual key 33 will change. After the desired channel is located, push “Enter” to enter next menu, as shown in FIG. 3(d). Meanwhile, the speech engine 5061 will generate a speech prompt, for example “For recording, please select the recording quality and the recording period”. After the user selects the desired recording period/quality, e.g. 2 hrs/SP, via the visual key 34 and then pushes the “Enter” button of the remote controller, the frame as shown in FIG. 3(e) will be shown. Meanwhile, the speech engine 5061 will generate a speech prompt, for example “For recording, please press Go to start”. After the user pushes the “Enter” button of the remote controller, the record operation starts.

Another example that settings for a record function is used herein to help with the understanding of the auxiliary operation interface according to the present invention. After the set-up menu is entered, the highlight cursor should be moved to the desired visual key 37 as shown in the set-up menu of FIG. 3(f) with the selection button 5051 to lock the item “Record” as the targeting item. During the above procedure, the audio process engine 5060 generates a sound prompt whenever the targeting item changes, i.e. the highlighted cursor changes, to identify the content of the selected item or to make a detailed description for the selected item. After the item “Record” is locked and the “Enter” button 5052 of the remote controller 505 is pressed down, the set-up for recording function is selected. Then, the sub-menu of FIG. 3(g) is shown for further settings. Meanwhile, the speech engine 5061 generates a speech prompt associated with the contents of this menu. Likewise, the audio process engine 5060 generates a sound prompt whenever the highlighted cursor changes. If the recording quality is selected by moving the highlight cursor to the desired visual key 38 on the screen with the selection button 5051, the speech engine 5061 will generate a speech prompt such as “For recording, please enter recording quality”. After the video source, the channel, the recording quality, and the recording period under the sub-menu of FIG. 3(g) are entered according to the above procedures, the highlight cursor should be moved to the visual key 39 for confirmation. After the “Enter” button 5052 of the remote controller 505 is pressed, the set-up tasks relevant to the recording function are finished. This example is illustrated by referring to a set-up key event. In addition, the auxiliary operation interface of the present invention can be used to execute other extensive functions such as file management or schedule setting.

In any case, when one of the selective items is locked as a targeting item, a speech prompt or an audio prompt can be outputted to describe what the visual key means and/or how it works. Upon the switching of the targeting item, a sound prompt is outputted for notifying purpose. Moreover, the audio process engine 5060 generates additional sound prompts to notify occurrences of specific operation events. Examples of the specific operation events include but are not limited to a selective item-switched event, a set-up completed event, a page-switched event, an execution waiting event, a task completed event, a warning event, a set-up result event, a file erasing event and a machine code correcting event. Depending on the manufacturer's design, the sound prompts relevant to different specific operation events are distinctive. In addition, the speech prompts generated by the speech engine 5061, for example, can be the recitation of the specific operation event, a warning content of the specific operation event and an operation purpose of the specific operation event.

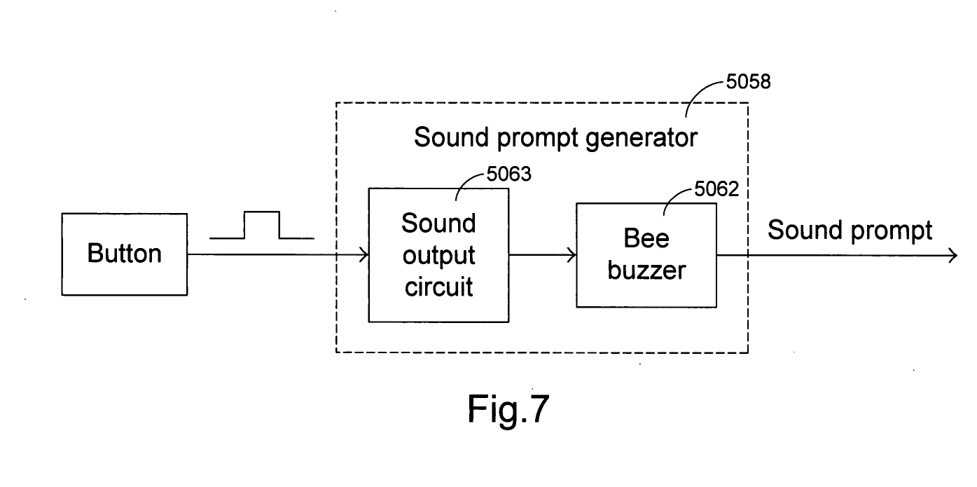

Moreover, an audio prompt can be generated when the digital recording/reproducing apparatus is powered on to indicate the current status of the recording/reproducing apparatus. Ideally, the shift of the targeting item and the switching of the guiding menu are revealed on the display immediately upon the corresponding buttons of the remote controller are pushed. Sometimes, however, the frame change on the screen is not as quick as expected so that whether the button of the remote controller is successfully triggered cannot be confirmed. Therefore, in addition to the sound and/or speech prompts generated by the audio process engine 5060 and/or speech engine 5061 when the digital recording/reproducing apparatus 500 is powered on and whenever the shift of the targeting item and the switching of the guiding menu are executed, as shown in FIG. 5, it is preferred that sound prompts can also be emitted in response to the effective triggering of the button of the remote controller. For confirming that the triggering of the button is effective, the remote controller 505 according to the present invention further comprises a sound prompt generator 5058 (see FIG. 7). When any button of the remote controller 505 is pressed down, a triggering signal is transmitted to the sound prompt generator 5058. In response to the triggering signal, the sound prompt generator 5058 generates a sound prompt to acknowledge the triggering of that button. The sound prompt generator 5058 may comprise a loudspeaker or bee buzzer 5062 to achieve this purpose. Depending on the manufacturer's design, the sound prompt generator 5058 can further comprise a sound output circuit 5063 to generate sound prompts varying with different triggering signals. For example, in response to the triggering signals from a functional button and from a numerical button, the sound prompts emitted from the loudspeaker or bee buzzer are distinguishable. Of course, the sound prompts can also be replaced with speech prompts, depending on manufacturer's design.

The above-mentioned sound prompts and the speech prompts, no matter if it is generated by the prompt generator in the digital recording/reproducing apparatus 500 or the remote controller 505, may be selected from several preset audio files. Alternatively, the audio files can be downloaded from a designated website via the Internet. For example, the audio files include speech prompts of different languages.

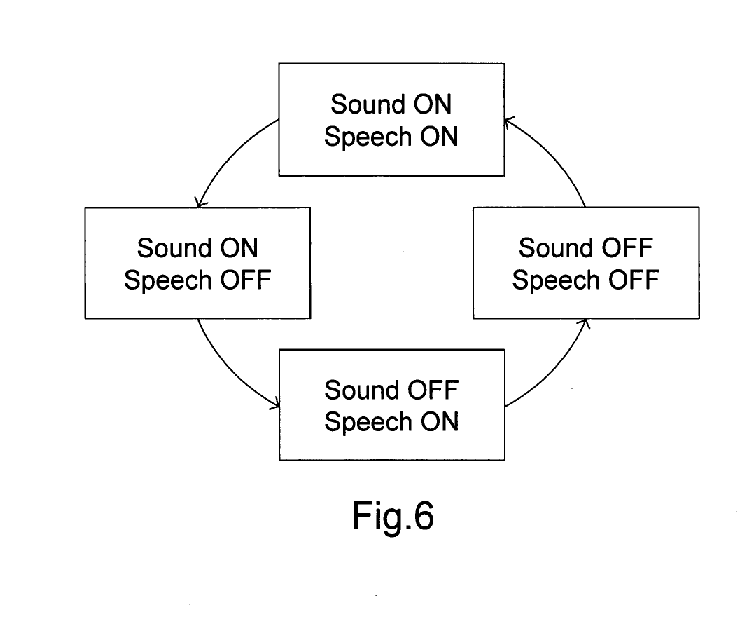

It is understood from the above description that the auxiliary operation interface capable of generating audio prompts according to the present invention facilitates the operation of the digital recording/reproducing apparatus. Nevertheless, the audio prompt function can be shut off when it is not necessary any more and restored at any time. Via the speech/sound prompt switching button 5053 of the remote controller, the audio process engine 5060 and the speech engine 5061 can be selectively and independently enabled and/or disabled for example according to the sequence shown in FIG. 6. In this example, the audio process engine 5060 and the speech engine 5061 are both enabled upon the actuating button 5050 of the remote controller 505 is pressed down to trigger a guider key event, i.e. upon the easy guider is entered. Once the switching button 5053 is pressed down, the speech engine 5061 is disabled but the audio process engine 5060 remains enabled. One more push of the switching button 5053 disables the audio process engine 5060 but enables the speech engine 5061. Subsequently, once the switching button 5053 is pressed down again, the audio process engine 5060 and the speech engine 5061 are both disabled. The switching cycle will be repeated by repetitively triggering the switching button 5053. Alternatively, instead of using the single switching button 5053 to switch phases as described above, the similar selectively enabling and/or disabling functions can be practiced by pushing respective exclusive buttons or a combination of buttons, each single one of which has been programmed for another function.

From the above description, the auxiliary operation interface of the present invention is advantageous for facilitating a user to operate a digital recording/reproducing apparatus with the aid of the sound/speech prompts.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An auxiliary operation interface of a digital recording/reproducing apparatus, comprising:
a guiding menu having a targeting item optionally triggered to have said digital recording/reproducing apparatus execute a selected function; and
an audio prompt generator enabled to generate a first audio prompt when said targeting item is triggered to enter a first function and generate a second audio prompt when said targeting item is triggered to enter a second function.

2. The auxiliary operation interface according to claim 1 wherein said guiding menu is shown on a screen coupled to said digital recording/reproducing apparatus and includes a plurality of selective items and said targeting item, and said first or second function is entered by switching said targeting item to selectively lock one of said selective items and triggering said targeting item.

3. The auxiliary operation interface according to claim 2 wherein one of said selective items is locked and said targeting item is triggered via a remote controller in communication with said digital recording/reproducing apparatus.

4. The auxiliary operation interface according to claim 3 wherein said first or second function is entered by triggering a button on said remote controller.

5. The auxiliary operation interface according to claim 1 wherein said first audio prompt and second audio prompt are speech prompts, and said audio prompt generator includes a speech engine.

6. The auxiliary operation interface according to claim 1 wherein said first audio prompt and second audio prompt are sound prompts, and said audio prompt generator includes an audio process engine.

7. The auxiliary operation interface according to claim 1 wherein said audio prompt generator includes a flash memory or hard disc drive for storing a plurality of audio files.

8. The auxiliary operation interface according to claim 1 wherein said audio prompt generator is implemented by integrated circuits for generating said first and second audio prompts.

9. The auxiliary operation interface according to claim 1 wherein said digital recording/reproducing apparatus is a DVD recorder or a DVD player.

10. A method for facilitating a user to operate a digital recording/reproducing apparatus, said method comprising steps of:
entering a first menu having a plurality of selective items and a targeting item;
optionally locking a first one of said selective items by switching said targeting item and triggering said targeting item to enter a second menu, or optionally locking a second one of said selective items by switching said targeting item and triggering said targeting item to enter a third menu;
generating a first audio prompt corresponding to said second menu when said second menu is entered; and
generating a second audio prompt corresponding to said third menu when said third menu is entered.

11. The method according to claim 10 wherein said first audio prompt and second audio prompt are speech prompts.

12. The method according to claim 11 wherein said first audio prompt and second audio prompt further comprise sound prompts.

13. The method according to claim 10 wherein said first or second menu is entered by triggering a button on a remote controller in communication with said digital recording/reproducing apparatus.

14. The method according to claim 10 wherein said targeting item is switched by triggering up/down selection keys on a remote controller in communication with said digital recording/reproducing apparatus, respectively.

15. The method according to claim 10 further comprising a step of generating a third audio prompt when said digital recording/reproducing apparatus is powered on.

16. The method according to claim 10 further comprising a step of selecting one of a plurality of audio files for generating said first or second audio prompts.

17. The method according to claim 16 wherein said audio files are speech files in a plurality of languages.

18. The method according to claim 16 wherein said audio files are stored in said digital recording/reproducing apparatus.

19. The method according to claim 16 wherein said audio files are downloaded from a designated website via the Internet.

20. An auxiliary operation interface of a digital recording/reproducing apparatus, comprising:
a guiding menu having a plurality of selective items; and
an audio prompt generator enabled to generate a first audio prompt when a first one of said selective items is selected as a targeting item, and generate a second audio prompt when a second one of said selective items is selected as the targeting item;
wherein said guiding menu is shown on a screen coupled to said digital recording/reproducing apparatus.

21. The auxiliary operation interface according to claim 20 wherein said selective items are selected via a remote controller in communication with said digital recording/reproducing apparatus.

22. The auxiliary operation interface according to claim 20 wherein said audio prompt generator further generates a third audio prompt when said first one of said selective item is entered for executing a selected function.

23. The auxiliary operation interface according to claim 20 wherein said audio prompt generator further generates additional sound prompts to notify occurrences of specific operation events that are selected from a group consisting of selective item-switched events, set-up completed events, page-switched events, execution waiting events, task completed events, warning events, set-up result events, file erasing events and a machine code correcting events.

24. The auxiliary operation interface according to claim 20 wherein said audio prompt generator includes an audio process engine, and said first and second audio prompts are sound prompts.

25. The auxiliary operation interface according to claim 20 wherein said audio prompt generator includes a speech engine, and said first and second audio prompts are speech prompts.

26. The auxiliary operation interface according to claim 20 wherein one of a plurality of audio files is selected to generate said first or second audio prompt.

27. The auxiliary operation interface according to claim 26 wherein said audio prompt generator includes a flash memory or hard disc drive for storing said plurality of audio files.

28. The method according to claim 26 wherein said audio files are downloaded from a designated website via the Internet.

29. The auxiliary operation interface according to claim 20 wherein said audio prompt generator is implemented by integrated circuits for generating said first and second audio prompts.

30. The auxiliary operation interface according to claim 20 wherein said digital recording/reproducing apparatus is a DVD recorder or a DVD player.

31. A method for facilitating a user to operate a digital recording/reproducing apparatus, said method comprising:
entering a guiding menu having a plurality of selective items;
generating a first audio prompt when a first one of said selective items is selected as a targeting item; and
generating a second audio prompt when a second one of said selective items is selected as the targeting item,
wherein said guiding menu is shown on a screen coupled to said digital recording/reproducing apparatus.

32. The method according to claim 31 wherein said method further comprising a step of generating a third audio prompt when said first one of said selective item is entered for executing a selected function.

33. The method according to claim 31 wherein said method further comprising a step of generating additional sound prompts to notify occurrences of specific operation events such as a selective item-switched event, a set-up completed event, a page-switched event, an execution waiting event, a task completed event, a warning event, a set-up result event, a file erasing event, or a machine code correcting event.

34. The method according to claim 31 wherein said first and second audio prompts are sound prompts.

35. The method according to claim 31 wherein said first and second audio prompts are speech prompts.

36. The method according to claim 31 wherein said method further comprising a step of selecting one of a plurality of audio files to generate said first or second audio prompt.

37. The method according to claim 36 wherein said audio files are downloaded from a designated website via the Internet.

38. The method according to claim 31 wherein said digital recording/reproducing apparatus is a DVD recorder or a DVD player.
